(19) United States
(12) Patent Application Publication
(10) Pub. No.: US 2014/0236665 A1
(43) Pub. Date: Aug. 21, 2014

(54) Automated Risk Management System and Method

(71) Applicant: Tamika M. Baker, San Antonio, TX (US)

(72) Inventor: Tamika M. Baker, San Antonio, TX (US)

(21) Appl. No.: 13/769,692

(22) Filed: Feb. 18, 2013

(51) Int. Cl. G06Q 10/06

(52) U.S. Cl. CPC G06Q 10/0635
USPC 705/7.28

(57) ABSTRACT

An automated risk management system connected to a computer network for use by a organization includes a server connected to the network, the server having a memory configured to store programming and data structures. The system includes a processor connected to the server and memory that is configured to execute the programming. The memory includes process flowchart data indicative of a organization's process objectives and controls. The memory may include regulatory data indicative of current regulations affecting the organization and risk assessment data indicative of potential risks, impacts, and likelihood of occurrence to the business. The system includes programming that automatically initiates searches of the internet using current process, regulatory, or risk assessment data and stores the search results in memory. Current data and search result data may be output to prompt a comparison of the same and, thus, require efficient management of potential risks.

### BACKGROUND OF THE INVENTION

This invention relates generally to risk management systems and, more particularly, to an automated risk management system that not only documents an organization's risk management program but proactively provides consultation by utilizing connection to the internet to determine improvements to processes, learn lessons from risks experienced by other organizations, and receive advance notice of new or coming regulations.

Risk management refers generally to the identification and assessment of events within an organization or agency that may yield negative impacts and then to implement procedures for managing those risks. Risk management frequently includes detailed flowcharts that identify specific processes or procedures within an organization and which can be regularly reviewed, updated based on past events, or used for training purposes. Unfortunately, updates to process flowcharts are often the result of a negative occurrence that reveals a risk that was not properly managed and which had a negative impact on the organization. Negative impacts may include financial loss, litigation, embarrassment of the organization or individuals, or even death.

Although risk management methods and systems are well known in the art, they almost always operate on hindsight experience rather than by proactively or consistently looking forward based on the newest information from regulatory agencies or the experience of other similar organizations.

Therefore, it would be desirable to have an automated risk management system that not only documents process flowcharts but that automatically searches the internet for articles or other data related to those flowcharts for the risk manager or committee to review. Further, it would be desirable to have an automated risk management system that searches the internet for the latest industry regulations or statutes based on known current regulations. In addition, it would be desirable to have an automated risk management system that is accessible online to a risk manager of an organization.

### SUMMARY OF THE INVENTION

An automated risk management system connected to a computer network for use by an organization according to the present invention includes a server electrically connected to the computer network, the server having a memory configured to store programming and data structures. The system includes a processor electrically connected to the server and to the memory that is configured to execute the programming. The memory includes process flowchart data indicative of an organization's process objectives and controls. The memory may include regulatory data indicative of current regulations affecting the organization. The memory may include risk assessment data indicative of potential risks, impacts, and likelihood of occurrence to the business.

The system includes programming that automatically initiates searches of the internet using process, regulatory, or risk assessment data and stores the search results in memory. Current data and search result data may be output to prompt a comparison of the same and, thus, require management of potential risks.

Therefore, a general object of this invention is to provide an automated risk management system that not only provides documentation of an organization's risk management processes and data but also provides automated consultation from relevant industries or regulatory agencies.

Another object of this invention is to provide an automated risk management system, as aforesaid, in which the automatic consulting data is derived from automatic internet searches based on current data stored in system relative to a respective organization.

Still another object of this invention is to provide an automated risk management system, as aforesaid, that imports process flowcharts created in other software and then automatically assigns predetermined objectives and controls to the flowchart data.

Yet another object of this invention is to provide an automatic risk management system, as aforesaid, that automatically assigns significance, type, and design ratios to a user input likelihood and impact risk assessment matrix.

A further object of this invention is to provide an automated risk management system, as aforesaid, that automatically searches the internet for articles and other data regarding compliance breaches and control breaks from similar industries so as to recommend proactive improvement to the organization's processes and controls.

A still further object of this invention is to provide an automated risk management system, as aforesaid, that brings all results of the system's components together at predetermined times to “force” evaluation of risk management controls and risks.

A still further object of this invention is to provide an automated risk management system, as aforesaid, that automatically searches relevant regulatory agencies or trade associations at predetermined times for updated or upcoming regulations that may impact the organization.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is an organizational block diagram of an automated risk management system according to a preferred embodiment of the present invention;

FIG. 2a is a block diagram of the electronic components of the system of FIG. 1;

FIG. 2b is a block diagram of the memory component shown in FIG. 2a;

FIGS. 3 to 6 are flowcharts illustrating the logic of the software of the system of FIG. 1; and

FIG. 7 is an example of a risk assessment matrix according to the present invention.

### DESCRIPTION OF THE PREFERRED EMBODIMENT

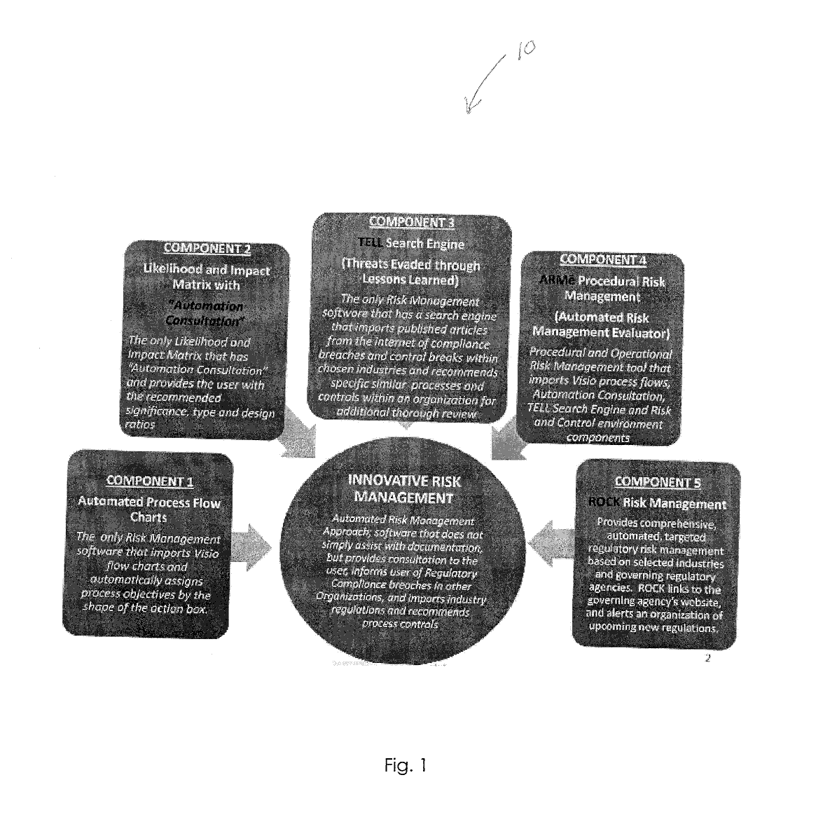

An automated risk management system according to a preferred embodiment of the present invention will be described in detail with reference to FIGS. 1 to 7 of the accompanying drawings. The risk management system 10 includes a server computer 18 in electrical communication with a wide area network such as the internet 12. Preferably, the system 10 may be accessed by connection to the internet, such as by a business, government, or other organization that is concerned with managing risk of liability and financial loss.

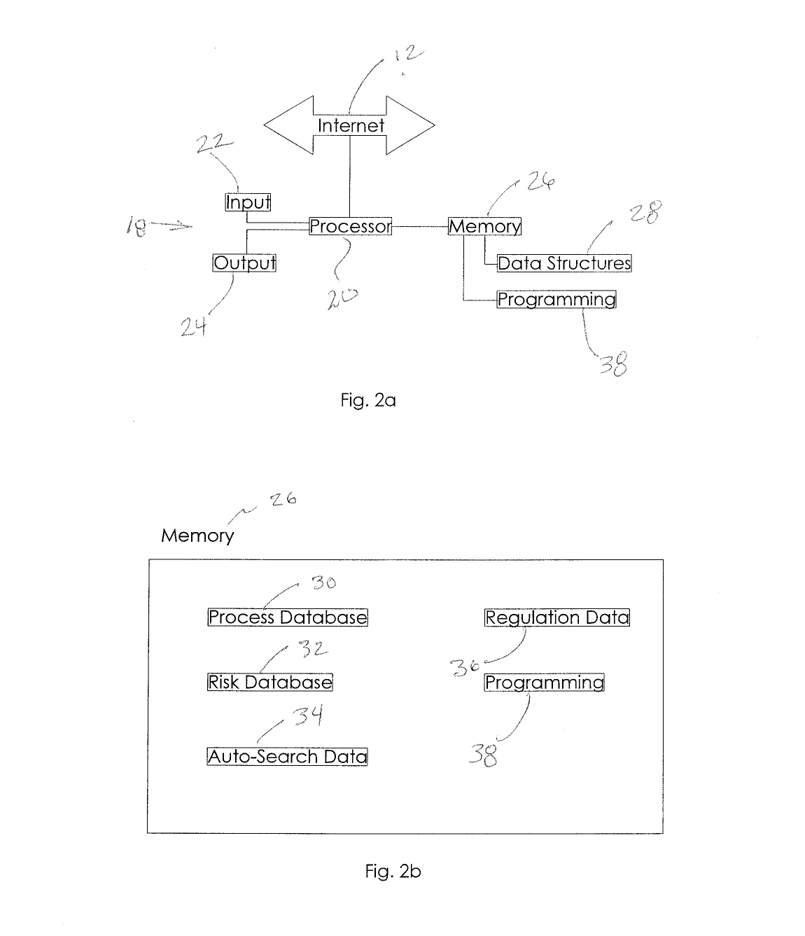

The server 12 is illustrated as a collection of its components in FIG. 2a and includes a processor 20, a memory 26, a data input 22, and a data output 24 as will be described more fully below. The memory 26 includes data structures 28 configured to store various types of data related to risk management and to store programming 38. The processor 20 is configured to execute the programming instructions. The memory 26 may include the following organization but is not limited thereto: a process database 30, a risk database 32, an auto-search data base 34 (which may also be referred to a search result database), and a regulation database 36. It is understood that reference to each database is a manner of showing the preferred organization or configuration of data storage in and retrieval from memory 38 but all data may appropriately be referred as merely “stored in memory” and will be understood by those in the art of programming.

The risk management system 10 includes a methodology defined by its software. The memory 38 includes various types of data that may be amended or edited by an authorized user. The first step in the process, then, is to authenticate any user attempting to access the system. The steps of authenticating a user of the system 10 is well known, such as through entry and verification of a username and password (not shown).

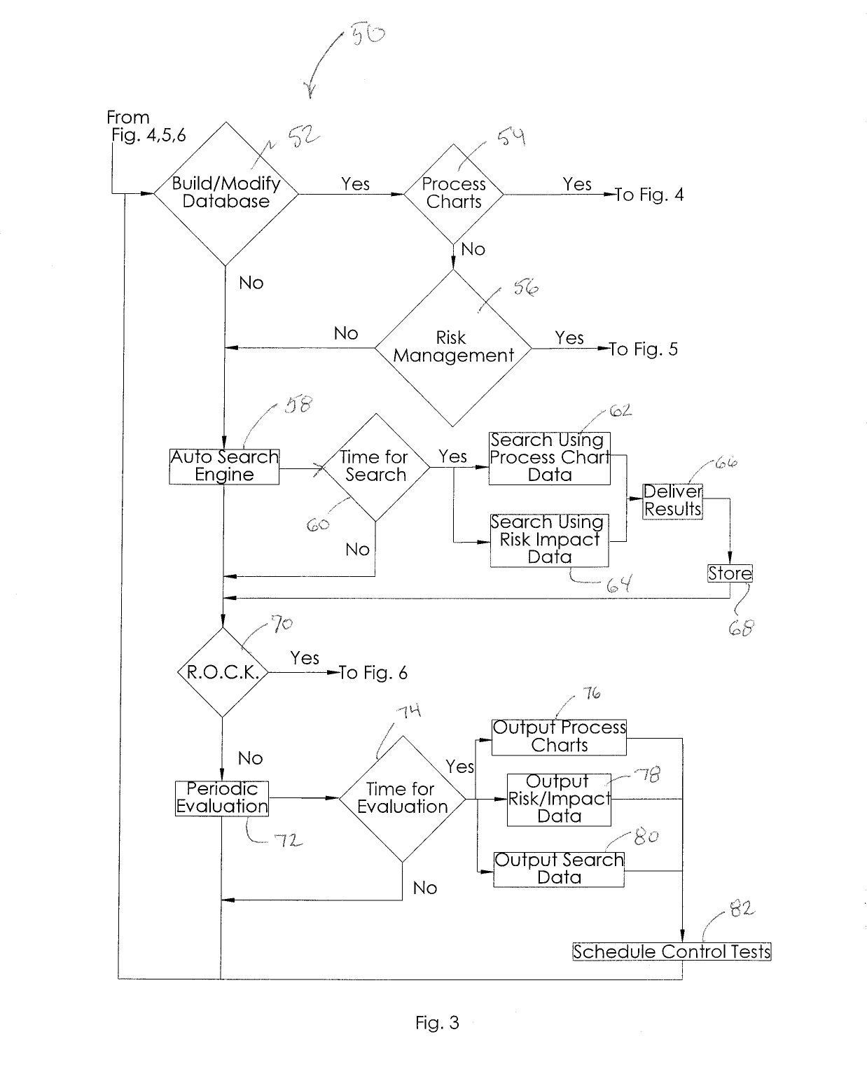

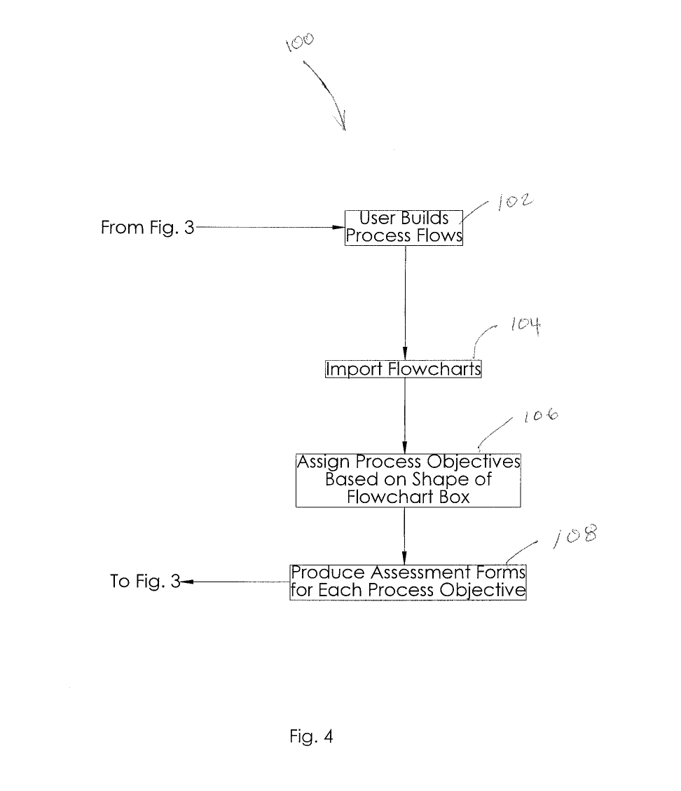

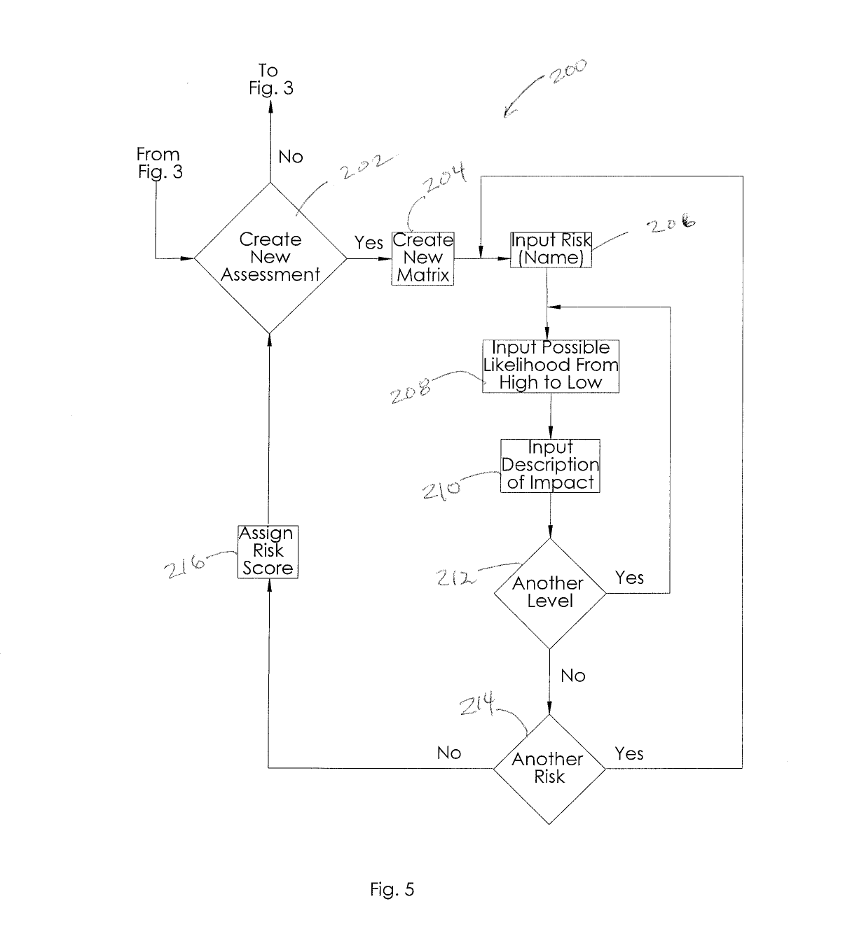

A process according to the present invention includes multiple “modes” or sub-processes (FIG. 1). One process 100 carried out by the system 10 concerns creating or modifying process flowcharts enables a user to import process flowcharts and have process objectives automatically assigned (FIG. 4). Another process 200 regards creating risk assessment matrices and automatically calculating data for consultation and evaluation (FIG. 5). Still another process (beginning at step 58) initiates automatic internet searches using data stored in either the process flow or risk assessment processes (FIG. 3). Process 58 is unique in that multiple searches may be built and initiated using a user's stored data with no overt action by the user and then the search results may be later compared or evaluated by the user so as to improve risk management. The process of search automation includes another process 300 that initiates one or more searches using regulatory data stored in memory 38 so as to proactively determine if updated regulations exist that should be considered. Still further, the system 10 includes steps (beginning at step 72) that bring together the process flows, the risk assessment results, the automatic search engine results for a user to evaluate/consult together (FIG. 3).

The overall process 50 is initiated as shown in FIG. 3 under the control of process 50. At step 52, the processor 20, under control of programming 38, determines if a user wants to build or modify data from an existing database (i.e. create, amend, or modify data in memory, such as to process flowcharts, risk assessment data, regulatory data or the like). If so, then the process 50 proceeds to the process 100 described in FIG. 4. Otherwise, process 50 proceeds to step 56. At step 56, the processor 20 determines if a user desires to input, modify, or review risk assessment data and, if so, proceeds to initiate process 200 illustrated in FIG. 5. Otherwise, the process 58 proceeds to step 58.

Process 100 illustrated in FIG. 4 will now be described so that the remainder of process 58 is more clearly understood. At step 102, a user is able to build a process flowchart or multiple flowcharts. As are understood by persons involved in risk management processes, a risk management flowchart utilizes symbols of various shapes to indicate actions, determinations, or other elements of an activity or evaluation so that respective personnel of an organization can understand actions to be taken to successfully manage an activity or avoid a negative outcome. Importantly, risk management or control flowcharts may be imported at step 104 from third party software such as that marketed as Microsoft Office Visio®. The process 100 then proceeds to step 106. The text and shape of each element of the flowchart are stored in the process database 30 in memory 26. At step 106, the processor 20 acts to automatically assign or associate predetermined objectives or controls according to the shapes of the imported flowcharts. It is understood that the predetermined data may have been stored previously in the process database 30 of the memory 26. This process data may later be retrieved for use in initiating process searches over the internet 12 as will be described later. The process 100 then proceeds to step 108 at which assessment forms or other documentation may be generated or stored for each process objective. Process is then received to step 52 of process 50 illustrated in FIG. 3.

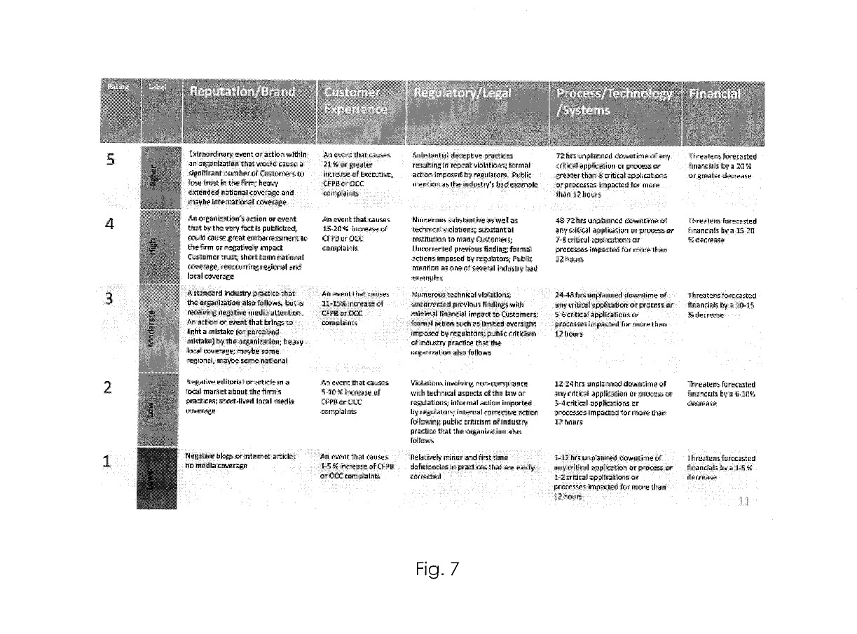

Process 200 illustrated in FIG. 5 will now be described so that the remainder of process 50 is understood more clearly. At step 202, the processor 20 determines if a user desires to create a new risk assessment and, if so, the process 200 proceeds to step 204. Otherwise, the process 200 returns control to step 52 illustrated in FIG. 3. At step 204, the processor 20 creates a risk matrix, such as the example shown in FIG. 7, that may be filled out by the user using an input 22 such as by text entered by a user remotely and received through the network 12. It is also possible that a user may upload a risk assessment matrix or access an existing matrix. At step 206, a particular risk event is identified and entered and the process 200 proceeds to step 208. At step 208, a user may indicate a level of likelihood of the risk occurring. The process 200 proceeds to step 210. At step 210, the user may input a description of potential impact if the risk is encountered. It is also contemplated that a user may enter or choose quantitative indications of the degree of likelihood of each risk in the matrix as well as the severity of harm if the risk occurs. Capturing these values is important so as to determine a risk score, design ratios, or the like as will be described below.

The process 200 then proceeds to step 212 at which the processor 20 determines if the user desires to add another level of severity to the current risk. In other words, the user may choose to indicate another possible impact and severity level relative to same risk as previously entered. If so, the process 200 returns to step 208; otherwise, control is passed to step 214. At step 214, the processor determines if the user desires to enter a completely new risk with its corresponding impacts/likelihood data. If so, the process 200 returns to step 206 at which a new risk may be entered as described above. Otherwise, the process 200 proceeds to step 216. At step 216, the processor 20 automatically calculates statistics based on the quantitative indications of likelihood and severity of impact of each risk or the overall risk matrix. Each matrix, associated data, and statistics are stored in the risk database 32 in memory 26. These statistics may be retrieved by another aspect of the system 10 as will be described later. Process 200 then returns to step 202 to determine if another risk assessment is desired. If not, control is returned to step 52 of process 50 illustrated in FIG. 3.

Turning again to FIG. 3, if the processor 20 determines at step 52, that a user does not desire to build or modify process or risk management data, the process 50 proceeds to step 58. At step 58, the process 50 enters an Auto-Search Engine module. The process 50 process proceeds to step 60. At step 60, the process 50 determines if it is time for a search to be initiated and, if so, the process 50 proceeds to step 62. Otherwise, the process 50 proceeds to step 70. Specifically, there may be programming instructions that require a search to be initiated automatically at predetermined intervals, such as weekly, monthly, or the like. At step 62, the processor 20 makes connection to an internet search engine, such as Google®.

Further, the processor 62 may access memory 26 and submit terms from the process database 30 to the search engine. It is understood that predetermined search engines may be used rather than a general search engine, such as one that allows searching only for published articles, trade papers, predetermined blog sites, etc. The process 50 proceeds to step 64 sequentially or in parallel with step 62. Specifically, the processor 20 may access the risk database 32 and submit particular terms to the search engine. It is understood that a user may have designated particular terms be used in automatic searches and these designations were saved in particular memory addresses. After the internet searches at steps 62 and 64, the process 50 proceeds to step 66 at which the search results may be immediately delivered to a risk manager or stored to the search result database 34 at step 68. The process 50 then proceeds to step 70.

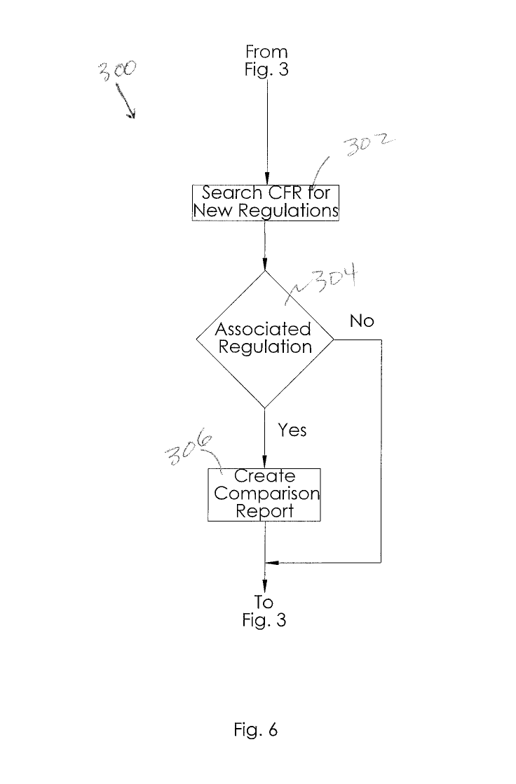

At step 70, the processor 20 determines if a user desires to engage process 400 for “Regulatory Oversight and Compliance Kit” (“ROCK”). If so, the process 50 transfers control to process 300 which is illustrated in FIG. 6; otherwise, the process 50 proceeds to step 72. The process 300 for the ROCK module is related to providing comprehensive, automated, and targeted regulatory risk management based on selected industries and governing regulatory agencies. A user is able to select the industry pertaining to his organization at the time of setup of the system 10. Current regulatory data governing that industry may be imported and stored in the regulation database 36. With reference to FIG. 6, the processor 20 initiates a search of respective regulatory rules and guidelines at step 302, such as may be provided in the Code of Federal Regulations (CFR) or other previously selected source of appropriate governing regulations. The process 300 then proceeds to step 304. At step 304, the processor 20 determines if new regulations associated with the existing regulatory framework have been found. More particularly, an internet search using current regulatory data may be performed so as to find updates to current regulations. If so, the processor 20 initiates a report comparing the old regulations with the new ones; otherwise the process 300 returns to step 52 of the process 50 illustrated in FIG. 3. After the comparison report has been generated, the process 300 returns to step 52 illustrated in FIG. 3. It is understood that the process 300 may include recommendations concerning a process, controls, or other information concerning regulatory updates.

Again with reference to FIG. 3, at step 72 a routine is entered which data from the previous processes is brought together for analysis.

It is understood that while certain forms of this invention have been illustrated and described, it is not limited thereto except insofar as such limitations are included in the following claims and allowable functional equivalents thereof.

1. An automated risk management system connected to a computer network for use by a organization, comprising:
a server electrically connected to the computer network, said server having a memory configured to store programming and data structures;
a processor situated in said server and electrically connected said memory that is configured to execute said programming;
wherein said memory includes process flowchart data indicative of a organization's process objectives and controls;
wherein said memory includes search result data received from automatic internet searches;
programming in said memory that, when executed by said processor, causes said processor to:
automatically initiate at least one search to a search engine over the computer network at a predetermined time using said process flowchart data stored in said memory; and
store a result of said process flowchart data search in said memory.

2. The automated risk management system as in claim 1, comprising programming in said memory that, when executed by said processor, causes said processor to allow a user in communication with said computer network to access said server after credential authentication.

3. The automated risk management system as in claim 1, comprising programming in said memory that, when executed by said processor, causes said processor to:
receive said flowchart data input by a user; and
store said process flowchart data in said memory.

4. The automated risk management system as in claim 3, further comprising programming in said memory that, when executed by said processor, causes said processor to automatically associate predetermined objectives and process controls to said flowchart data input by said user.

5. The automated risk management system as in claim 4, comprising programming in said memory that, when executed by said processor, causes said processor to:
receive current regulatory data input by a user, said regulatory data being indicative of current regulations affecting the organization; and
store said current regulatory data in said memory.

6. The automated risk management system as in claim 1, comprising programming in said memory that, when executed by said processor, causes said processor to:
receive current regulatory data input by a user, said regulatory data being indicative of current regulations affecting the organization; and
store said current regulatory data in said memory.

7. The automated risk management system as in claim 6, comprising programming in said memory that, when executed by said processor, causes said processor to:
automatically initiate at least one search to a search engine over the computer network at a predetermined time using said current regulatory data stored in said memory; and
store a result of said current regulatory data search in said memory.

8. The automated risk management system as in claim 5, comprising:
programming in said memory that, when executed by said processor, causes said processor to:
automatically initiate at least one search to a search engine over the computer network at a predetermined time using said current regulatory data stored in said memory; and
store a result of said current regulatory data search in said memory.

9. The automated risk management system as in claim 1, comprising programming in said memory that, when executed by said processor, causes said processor to receive risk assessment data input by a user and store said risk assessment data in said memory.

10. The automated risk management system as in claim 9, wherein said risk assessment data includes impact data and likelihood of occurrence data; and
said automated risk management system including programming in said memory that, when executed by said processor, causes said processor to calculate significance of risk ratios based on said impact data and likelihood of occurrence data.

11. The automated risk management system as in claim 9, comprising programming in said memory that, when executed by said processor, causes said processor to:
automatically initiate at least one search to a search engine over the computer network at a predetermined time using said risk assessment data stored in said memory; and
store a result of said risk assessment data search in said memory.

12. The automated risk management system as in claim 11, wherein said memory includes a risk database configured to store said risk assessment data.

13. The automated risk management system as in claim 7, wherein said memory includes:
a process database configured to store said process flowchart data;
a search result database configured to store said result of said process flowchart data search; and
a regulatory data configured to store said result of said current regulatory data search.

14. The automated risk management system as in claim 7, comprising programming in said memory that, when executed by said processor, causes said processor to receive risk assessment data input by a user and store said risk assessment data in said memory, wherein said risk assessment data includes impact data and likelihood of occurrence data;
wherein said automated risk management system includes programming in said memory that, when executed by said processor, causes said processor to:
calculate significance of risk ratios based on said impact data and likelihood of occurrence data;
automatically initiate at least one search to a search engine over the computer network at a predetermined time using said risk assessment data stored in said memory; and
store a result of said risk assessment data search in said memory;
output said process flowchart data, said process flowchart data search result, said current regulatory data result, and said risk assessment data search result.

15. An automated risk management system connected to a computer network for use by a organization, comprising:
a server electrically connected to the computer network, said server having a memory configured to store programming and data structures;
a processor in said sever and electrically connected to said memory that is configured to execute said programming;
a regulatory database stored in said memory that includes regulatory data being indicative of current regulations affecting the organization;
a search result database located in said memory that includes search data received from automatic internet searches;
programming in said memory that, when executed by said processor, causes said processor to:
automatically initiate at least one search to a search engine over the computer network at a predetermined time using said regulatory data stored in said regulatory database; and
store a result of said regulatory data search in said search result database.

16. The automated risk management system as in claim 15, comprising programming in said memory that, when executed by said processor, causes said processor to:
receive current regulatory data input by a user and store said input data in said regulatory database, said regulatory data being indicative of current regulations affecting the organization; and
store said current regulatory data in said regulatory database.

17. The automated risk management system as in claim 15, comprising:
wherein said memory includes a process database having process flowchart data indicative of a organization's process objectives and controls;
programming in said memory that, when executed by said processor, causes said processor to:
automatically initiate at least one search to a search engine over the computer network at a predetermined time using said process flowchart data stored in said process database; and
store a result of said process flowchart data search in said search result database.

18. The automated risk management system as in claim 17, comprising programming in said memory that, when executed by said processor, causes said processor to:
receive said flowchart data input by a user;
store said process flowchart data in said memory;
automatically associate predetermined objectives and process controls to said flowchart data input by said user.

19. The automated risk management system as in claim 18, causes said processor to receive risk assessment data input by a user and store said risk assessment data in said memory.

20. The automated risk management system as in claim 15, causes said processor to receive risk assessment data input by a user and store said risk assessment data in said memory.

21. The automated risk management system as in claim 20, wherein said risk assessment data includes impact data and likelihood of occurrence data; and
said automated risk management system comprising programming in said memory that, when executed by said processor, causes said processor to calculate significance of risk ratios based on said impact data and said likelihood of occurrence data.

22. The automated risk management system as in claim 21, comprising programming in said memory that, when executed by said processor, causes said processor to:
automatically initiate at least one search to a search engine over the computer network at a predetermined time using said risk assessment data stored in said memory; and
store a result of said risk assessment data search in said search result database.

23. The automated risk management system as in claim 15, wherein said memory includes a risk database configured to store said risk assessment data.

24. The automated risk management system as in claim 22, comprising programming that when executed causes said processor to output said current regulatory data search result and said risk assessment data search result.

25. A method for automatically managing risk of a organization using a computer connected to the internet and having an input, comprising:
providing an electronic memory having data structures configured to store process flowchart data indicative of a organization's process objectives;
automatically initiating a search of the internet at a predetermined time using said flowchart data;
storing a result of said flowchart data search in said memory; and
outputting said flowchart data search result and said flowchart data for comparison.

26. The method for automatically managing risk as in claim 25, further comprising:
receiving said process flowchart data input by a user;
storing said input process flowchart data in said memory; and
automatically associate predetermined objectives and controls with said input process flowchart data.

27. The method for automatically managing risk as in claim 25, wherein said memory includes regulatory data being indicative of current regulations affecting the organization.

28. The method for automatically managing risk as in claim 25, comprising:
receive current regulatory data input by a user, said regulatory data being indicative of current regulations affecting the organization;
storing said input regulatory data in said memory;
automatically initiating a search of the internet at a predetermined time using said current regulatory data;
storing a result of said current regulatory data search in said memory; and
outputting said current regulatory data and said current regulatory data search result so that a comparison is selectively made.

29. The method for automatically managing risk as in claim 25, wherein said memory includes data structures for storing risk assessment data indicative of impact data and likelihood of occurrence data;
said method for automatically managing risk includes:
receiving said risk assessment data input by a user;
storing said risk assessment data in said memory;
automatically initiating at least one search to a search engine over the computer network at a predetermined time using said risk assessment data stored in said memory; and
storing a result of said risk assessment data search in said search result database.

30. The method for automatically managing risk as in claim 29, comprising outputting said risk assessment data and said risk assessment data search result so as to facilitate a comparison thereof.
